(19) United States
(12) Patent Application Publication
(10) Pub. No.: US 2026/0131736 A1
(43) Pub. Date: May 14, 2026

(54) COVERING SHELF APPARATUS FOR A VEHICLE

(71) Applicants: HYUNDAI MOTOR COMPANY, Seoul (KR); KIA CORPORATION, Seoul (KR); SEOYON E-HWA CO., LTD., Anyang-si (KR)

(72) Inventors: Jin Seok Yoon, Hwaseong-si (KR); Jae Eun Chang, Hwaseong-si (KR); Seung Joon Lee, Uiwang-si (KR)

(73) Assignees: HYUNDAI MOTOR COMPANY, Seoul (KR); KIA CORPORATION, Seoul (KR); SEOYON E-HWA CO., LTD., Anyang-si (KR)

(21) Appl. No.: 19/073,586

(22) Filed: Mar. 7, 2025

(30) Foreign Application Priority Data
Nov. 13, 2024 (KR) 10-2024-0161182

(51) Int. Cl. B60R 5/04; F16F 15/08

(52) U.S. Cl. CPC B60R 5/045; F16F 15/08; F16F 2230/00; F16F 2230/0005; F16F 2230/02; F16F 2230/36

(57) ABSTRACT

A covering shelf apparatus for a vehicle includes a covering shelf disposed rearward of the second-row seat of the vehicle. The covering shelf may be accommodated and stored in an upwardly inclined position using a simple and robust structure when the covering shelf is not in use. The covering shelf apparatus further includes a damper 300 coupled to the covering shelf 100 may be utilized to reduce or eliminate rattle noise occurring while the vehicle is in motion.

### CROSS-REFERENCE TO RELATED APPLICATION

The present application claims priority to Korean Patent Application No. 10-2024-0161182, filed on Nov. 13, 2024, the entire contents of which are incorporated herein by reference.

### BACKGROUND

### Field

The present disclosure relates to a covering shelf apparatus for a vehicle.

### Description of the Related Art

In general, a vehicle, which has a luggage compartment between a second-row seat and a tail gate, may be equipped with a covering shelf configured to shield the luggage compartment.

When the covering shelf is used, the covering shelf is installed to extend from an upper side of a luggage side trim in a forward and rearward direction (i.e., a forward/rearward direction). When the covering shelf is not used, the covering shelf is left unattended in the luggage compartment when there is no separate storage or method for the covering shelf. Even though there is the separate storage or method, the complicated storage method may cause an inconvenient situation.

In addition, it is desired to prevent noise (rattle noise) from occurring while the vehicle is in motion, regardless of whether the covering shelf is in use or not.

The foregoing explained as the background is intended merely to aid in the understanding of the background of the present disclosure, and is not intended to mean that the present disclosure falls within the purview of the related art that is already known to those having ordinary skill in the art.

### SUMMARY

The present disclosure provides a covering shelf apparatus for a vehicle. The covering shelf apparatus includes a covering shelf that is disposed rearward of the second-row seat of the vehicle and accommodated and stored to be inclined upward (e.g., in an upwardly inclined position) using a simple and robust structure when the covering shelf is not in use, such that the occurrence of noise may be prevented, and convenience and marketability may be improved.

In some embodiments of the present disclosure, a covering shelf apparatus for a vehicle includes: a covering shelf; side brackets fixedly and respectively coupled to side surfaces of the covering shelf; and dampers fixedly and respectively coupled to the side surfaces of the covering shelf.

In one embodiment, the side brackets are fixedly and respectively coupled to the side surfaces of the covering shelf at forward end positions thereof, based on a forward and rearward direction of the vehicle. The dampers are fixedly and respectively coupled to the side surfaces of the covering shelf at rearward end positions thereof, based on the forward and rearward direction of the vehicle.

The covering shelf, to which the side brackets and the dampers are coupled, may be installed to extend from an upper side of a luggage side trim in a forward and rearward direction when the covering shelf is in use. When the covering shelf is not in use, the covering shelf may be positioned rearward of a second-row seat of the vehicle and stored to be inclined upward (i.e., in an upwardly inclined position).

In some embodiments, a first protrusion may extend from a front side of an upper end of the luggage side trim. The front side of the upper end of the luggage side trim faces the second-row seat. A seating portion may extend in the forward and rearward direction and is provided at the upper end of the luggage side trim and spaced apart rearward from the first protrusion. When the covering shelf is in use, the first protrusion may be fitted with a corresponding side bracket among the side brackets, and a damper among the dampers may be seated on the seating portion, such that the covering shelf may be installed to extend from the upper side of the luggage side trim in the forward and rearward direction.

In an embodiment, a second protrusion may extend from a position on the luggage side trim, wherein the position is located downward and forward relative to the first protrusion. When the covering shelf is not in use, the second protrusion may be fitted with the corresponding side bracket, and the first protrusion may be fitted with the damper, such that the covering shelf may be positioned rearward of the second-row seat and stored in the upwardly inclined position.

In a state in which the covering shelf stands upright so that the side bracket is positioned lower than the damper when the covering shelf is installed rearward of the second-row seat and inclined upward, the second protrusion may be fitted with and coupled to the side bracket first, the covering shelf may be rotated downward about the second protrusion by pushing downward an upper end of the covering shelf having the damper, the damper may be moved to the first protrusion by rotating the covering shelf, and then the first protrusion may be fitted with and coupled to the damper, such that the covering shelf may be completely installed to be inclined upward.

In an embodiment, when changing the covering shelf to the upwardly inclined position from a state in which the covering shelf stands upright and the corresponding side bracket is positioned lower than the damper, the second protrusion fitted with the corresponding side bracket is configured to allow the covering shelf to rotate downward about the second protrusion when an upper end of the covering shelf is pushed downward such that the damper is moved to the first protrusion and then coupled to the damper.

In an embodiment, a bracket hole may be formed in the corresponding side bracket, the first protrusion may be penetratively fitted into the bracket hole when the covering shelf is used, and the second protrusion may be penetratively fitted into the bracket hole when the covering shelf is not used.

In an embodiment, each of the dampers may be formed as an integrated elastic body to absorb an impact and prevent noise.

In an embodiment, a damper hole may be formed in the damper, and the first protrusion may be penetratively fitted into the damper hole when the covering shelf is used.

In an embodiment, a stopper protrusion may be formed in an inlet of the damper hole and protrude toward the inside of the damper hole to prevent the first protrusion, which is fitted into the damper hole, from being withdrawn.

In an embodiment, a bottom surface of the damper may protrude to the outside of the covering shelf, and the bottom surface of the damper may be in contact with the seating portion provided on the luggage side trim to prevent noise when the covering shelf is used.

In an embodiment, a noise prevention protrusion may be formed on the bottom surface of the damper and provided to be in contact with the seating portion.

In an embodiment, a plurality of fixing protrusions may be formed on the dampers, and the fixing protrusions may be installed to penetrate the covering shelf to prevent the dampers from separating from the covering shelf.

The covering shelf apparatus for a vehicle according to the present disclosure is configured such that the covering shelf may be disposed rearward of the second-row seat and accommodated and stored to be inclined upward by using the simple, robust structure when the covering shelf is not used, such that the convenience of the storage operation may be improved, and the marketability may be improved.

In addition, the covering shelf apparatus according to the present disclosure is configured such that the damper coupled to the covering shelf may be utilized to reduce or eliminate rattle noise occurring when the vehicle travels, such that the marketability may be improved.

The effects obtained by the present disclosure are not limited to the aforementioned effects, and other effects, which are not mentioned above, should be clearly understood by those having ordinary skill in the art from the following description.

### BRIEF DESCRIPTION OF THE DRAWINGS

FIG. 1 is a view illustrating a state in which a covering shelf, to which a side bracket and a damper are coupled, is installed according to an embodiment of the present disclosure.

FIG. 2 is a view illustrating a process in which the covering shelf in FIG. 1 switches to a stored state.

FIG. 3 is a view illustrating a state in which the covering shelf is installed rearward of a second-row seat and stored to be inclined upward.

FIGS. 4 to 6 are views illustrating a first protrusion, a seating portion, and a second protrusion formed on a luggage side trim in embodiments of the present disclosure.

FIG. 7 is a view illustrating the covering shelf to which the side bracket and the damper according to the present disclosure are coupled.

FIGS. 8 to 10 are views for explaining a damper according to an embodiment of the present disclosure.

FIG. 11 is a view for explaining the side bracket according to an embodiment of the present disclosure.

FIG. 12 is a view illustrating a state in which the first protrusion is coupled to the damper according to the present disclosure.

### DETAILED DESCRIPTION

In the description of the embodiments disclosed in the present disclosure, the specific descriptions of publicly known related technologies have been omitted when it is determined that the specific descriptions may obscure the subject matter of the embodiments disclosed in the present disclosure. In addition, it should be interpreted that the accompanying drawings are provided only to allow those having ordinary skill in the art to easily understand the embodiments disclosed in the present disclosure, and the technical spirit disclosed in the present disclosure is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

When a component, device, element, or the like of the present disclosure is described as having a purpose or performing an operation, function, or the like, the component, device, or element should be considered herein as being “configured to” meet that purpose or to perform that operation or function.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, the term “control unit” or “unit” included in the name of “motor control unit (MCU)” or “hybrid control unit (HCU)” is merely a term widely used to name a control device (controller or control unit) for controlling a particular vehicle function but does not mean a generic function unit.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

Hereinafter, embodiments disclosed in the present specification are described in detail with reference to the accompanying drawings. The same or similar constituent elements are assigned with the same reference numerals regardless of reference numerals, and the repetitive description thereof is omitted.

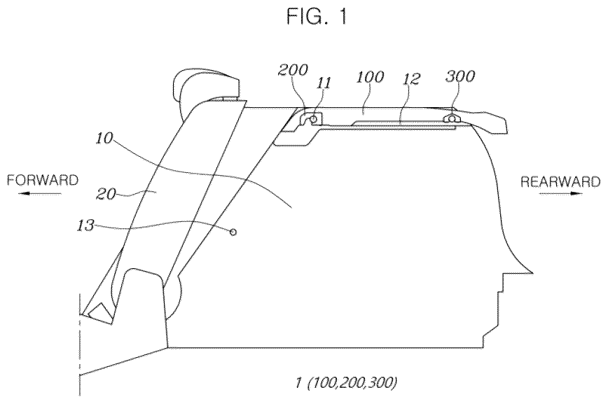

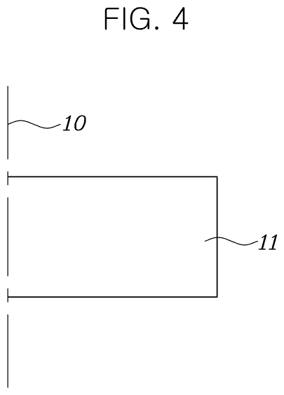

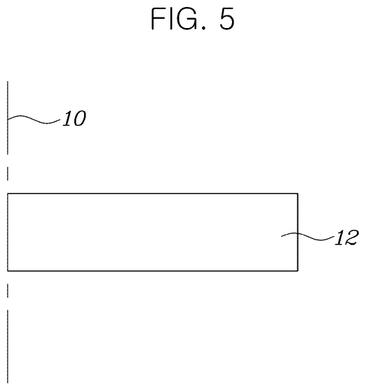

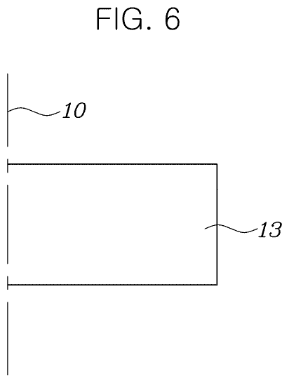

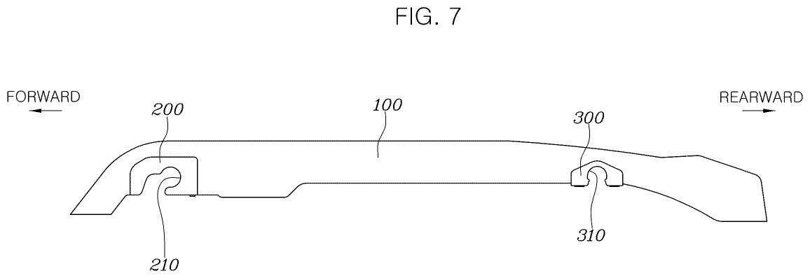

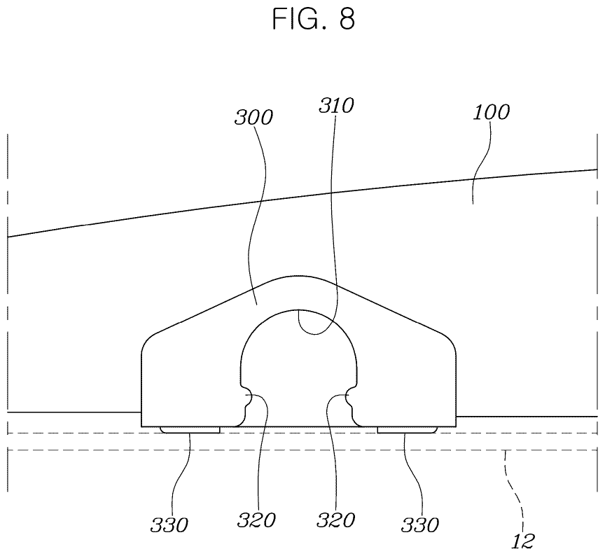

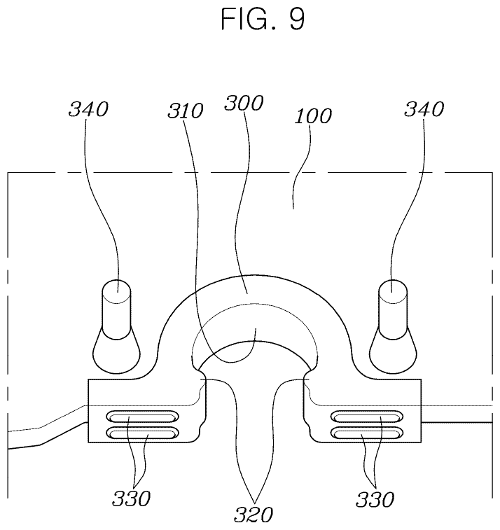

According to some embodiments of the present disclosure, as illustrated in FIGS. 1 to 12, a covering shelf apparatus 1 for a vehicle may include a covering shelf 100, side brackets 200, and dampers 300. In an embodiment, the side brackets 200 and the dampers 300 are arranged along side surfaces (e.g., left and right side surfaces) of the covering shelf 100. For example, as illustrated in FIG. 1, on the left side surface, the side bracket 200 is positioned in front of the damper 300, with both fixedly coupled to the left side surface of the covering shelf 100. Similarly, on the right side surface, another side bracket 200 is positioned in front of another damper 300, with both fixedly coupled to the right side surface of the covering shelf 100. The right and left side surfaces of the covering shelf 100 face each other in its longitudinal direction. In other words, the side brackets 200 are fixedly and respectively coupled to the left and right side surfaces of the covering shelf 100, and dampers 300 are fixedly and respectively coupled to the left and right side surfaces of the covering shelf 100.

With reference to FIG. 1, the covering shelf 100, to which the side bracket 200 and the damper 300 are coupled, may be installed to extend in a forward and rearward (hereinafter, a forward/rearward direction) on an upper side of a luggage side trim 10 when the covering shelf 100 is in use.

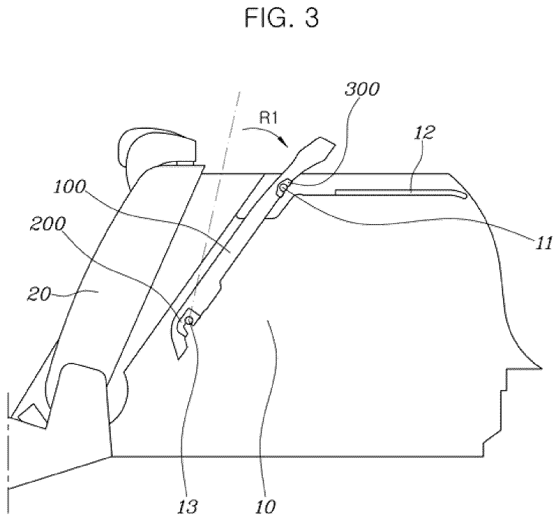

Further, with reference to FIG. 3, the covering shelf 100, to which the side bracket 200 and the damper 300 are coupled, may be positioned rearward of the second-row seat 20 and stored to be inclined upward (i.e., in an upwardly inclined position) when the covering shelf 100 is not in use.

FIG. 1 illustrates the state in which the covering shelf 100 is in use. In an embodiment, the side brackets 200 may be fixedly and respectively coupled to the the side surfaces (e.g., the left and right side surfaces) of the covering shelf 100 at their forward end positions, based on the covering shelf's forward/rearward direction. In another embodiment, the dampers 300 may be fixedly and respectively coupled to the side surfaces (e.g., the left and right side surfaces) of of the covering shelf 100 at their rearward end positions, based on the covering shelf's forward/rearward direction.

According to an embodiment of the present disclosure, a first protrusion 11 may extends from a front side of an upper end of the luggage side trim 10, facing the second-row seat 20, and a seating portion 12 may extend in the forward/rearward direction and is disposed at the upper end of the luggage side trim 10 and spaced apart rearward from the first protrusion 11.

Both the first protrusion 11 and the seating portion 12 may be provided to protrude toward the inside of a luggage compartment.

With reference to FIG. 1, when the covering shelf 100 is in use, the first protrusion 11 is fitted with the side bracket 200, and the damper 300 is seated on the seating portion, such that the covering shelf 100 may be installed to extend from the upper side of the luggage side trim 10 in the forward/rearward direction.

According to an embodiment of the present disclosure, a second protrusion 13 may protrude from a position on the luggage side trim 10, which is located downward and forward relative to the first protrusion 11.

The second protrusion 13 may be provided to protrude toward the inside of the luggage compartment.

With reference to FIG. 3, when the covering shelf 100 is not in use, the second protrusion 13 is fitted with the side bracket 200, and the first protrusion 11 is fitted with the damper 300, such that the covering shelf 100 may be installed rearward of the second-row seat 20 and stored to be inclined upward (e.g., stored in its an upwardly inclined position).

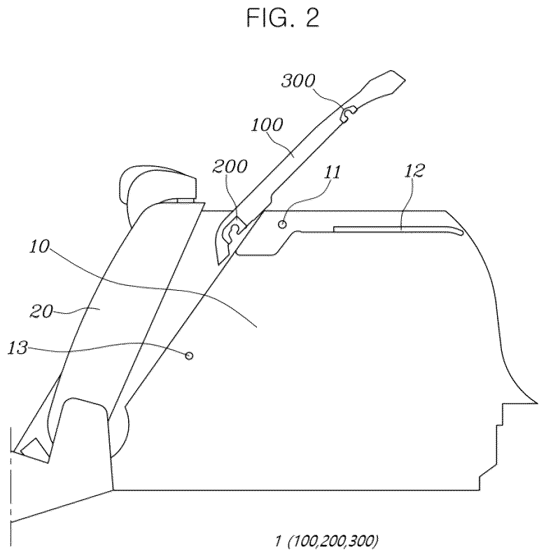

FIG. 1 is a view illustrating the state in which the covering shelf 100 is installed, FIG. 3 is a view illustrating the state in which the covering shelf 100 is installed rearward of the second-row seat 20 and stored in its upwardly inclined position, and FIG. 2 is a view illustrating a process in which the state changes from the state in FIG. 1 to the state in FIG. 3.

In order to allow the covering shelf 100, which is installed as illustrated in FIG. 1, to switch to the stored state (i.e., the upwardly inclined position) illustrated in FIG. 3, an operator releases a fixed portion of the covering shelf 100 first, detaches the covering shelf 100, and then lifts the covering shelf 100 to stand the covering shelf 100 in an upward and downward direction (i.e., stand upright), as illustrated in FIG. 2.

As illustrated in FIG. 2, when the covering shelf 100 stands in the upward/downward direction, the side bracket 200 is positioned at the lower side, and the damper 300 is positioned at the upper side. In other words, the side bracket 200 is positioned lower than the damper 300.

As illustrated in FIG. 2, the covering shelf 100 is moved downward in the state in which the covering shelf 100 stands upright, the second protrusion 13 is fitted with and coupled to the side bracket 200 first, the covering shelf 100 is rotated downward about the second protrusion 13 by pushing downward the upper end of the covering shelf 100 having the damper 300 (see the arrow R1 in FIG. 3), the damper 300 is moved to the first protrusion 11 by rotating the covering shelf 100, and then the first protrusion 11 is fitted with and coupled to the damper 300, such that the covering shelf 100 may be installed rearward of the second-row seat 20 and inclined upward.

The above-mentioned method of storing the covering shelf 100 may be simple in workability without being complicated. In particular, the covering shelf 100 may be more robustly installed and stored to be inclined upward by coupling the side bracket 200 and the second protrusion 13 and coupling the damper 300 and the first protrusion 11, such that the convenience and marketability of the operation may be improved.

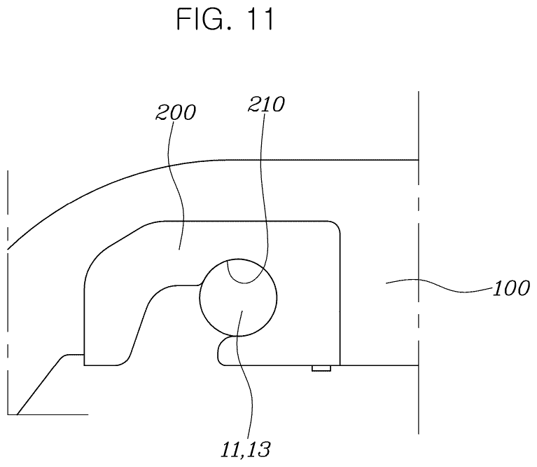

With reference to FIG. 11, a bracket hole 210 may be formed in the side bracket 200. To use the covering shelf 100, the first protrusion 11 may be penetratively fitted into the bracket hole 210. When the covering shelf 100 is not in use, the second protrusion 13 may be penetratively fitted into the bracket hole 210.

According to an embodiment of the present disclosure, the dampers 300 may be formed as integrated elastic bodies to absorb an impact and prevent noise. For example, the dampers 300 may be made of rubber. However, the present disclosure is not limited thereto.

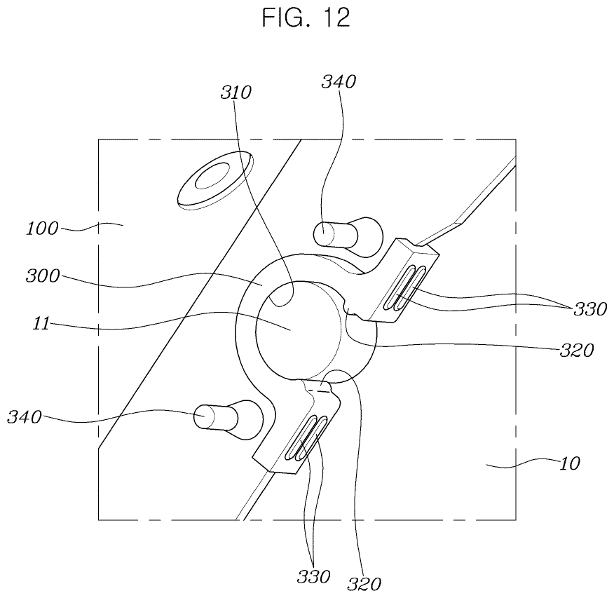

With reference to FIG. 12, a damper hole 310 may be formed in the damper 300, and the first protrusion 11 may be penetratively fitted into the damper hole 310 when the covering shelf 100 is used.

In an embodiment, stopper protrusions 320 may be formed in an inlet of the damper hole 310 and protrude toward the inside of the damper hole 310 to prevent the first protrusion 11, which is fitted into the damper hole 310, from being withdrawn.

The stopper protrusions 320 may be formed symmetrically at positions based on the forward/rearward direction in the inlet of the damper hole 310. Therefore, the stopper protrusions 320 may prevent the first protrusion 11, which is fitted into the damper hole 310, from being withdrawn in the forward/rearward direction.

In an embodiment, a bottom surface of the damper 300 may protrude to the outside of the covering shelf 100. When the covering shelf 100 is used, the bottom surface of the damper 300 may be in contact with the seating portion 12 provided on the luggage side trim 10 and maximally suppress the occurrence of rattle noise occurring when the vehicle travels.

In more detail, noise prevention protrusions 330 may be formed on the bottom surface of the damper 300 and be in contact with the seating portion 12.

The noise prevention protrusion 330 may induce a line contact with the seating portion 12, thereby maximally suppressing the occurrence of rattle noise occurring when the vehicle travels.

The noise prevention protrusions 330 may be provided as two or more noise prevention protrusions 330. However, the present disclosure is not limited thereto.

According to an embodiment of the present disclosure, a plurality of fixing protrusions 340 may be formed on the dampers 300. The fixing protrusions 340 may be installed to penetrate the covering shelf 100 and prevent the dampers 300 from separating from the covering shelf 100.

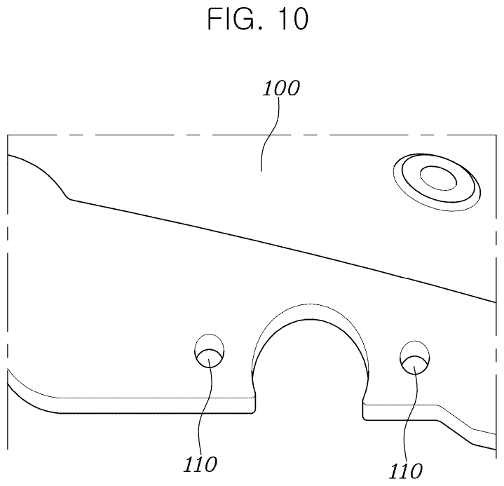

With reference to FIG. 10, two protrusion coupling holes 110 may be formed in the covering shelf 100 and spaced apart from each other, and two fixing protrusions 340 may be formed on the damper 300, such that the fixing protrusions 340 may be respectively penetratively coupled to the protrusion coupling holes 110.

As described above, the covering shelf apparatus 1 for a vehicle according to the present disclosure is configured such that the covering shelf 100 may be disposed rearward of the second-row seat 20 and accommodated and stored to be inclined upward by using the simple, robust structure when the covering shelf 100 is not used, such that the convenience of the storage operation may be improved, and the marketability may be improved.

In addition, the covering shelf apparatus 1 according to the present disclosure is configured such that the damper 300 coupled to the covering shelf 100 may be utilized to reduce or eliminate rattle noise that occurs when the vehicle travels, such that the marketability may be improved.

While the specific embodiments of the present disclosure have been illustrated and described, it should be obvious to those having ordinary skill in the art that the present disclosure may be variously modified and changed without departing from the technical spirit of the present disclosure defined in the appended claims.

What is claimed is:

1. A covering shelf apparatus for a vehicle, the covering shelf apparatus comprising:
a covering shelf;
side brackets fixedly and respectively coupled to side surfaces of the covering shelf; and
dampers fixedly and respectively coupled to the side surfaces of the covering shelf.

2. The covering shelf apparatus of claim 1, wherein:
the side brackets are fixedly and respectively coupled to the side surfaces of the covering shelf at forward end positions thereof, based on a forward and rearward direction of the vehicle; and
the dampers are fixedly and respectively coupled to the side surfaces of the covering shelf at rearward end positions thereof, based on the forward and rearward direction of the vehicle.

3. The covering shelf apparatus of claim 1, wherein the covering shelf, to which the side brackets and the dampers are coupled, is installed to extend from an upper side of a luggage side trim in a forward and rearward direction of the vehicle when the covering shelf is in use, and
wherein when the covering shelf is not in use, the covering shelf is positioned rearward of a second-row seat and stored in an upwardly inclined position.

4. The covering shelf apparatus of claim 3, wherein a first protrusion extends from a front side of an upper end of the luggage side trim, wherein the front side of the upper end of the luggage side trim faces the second-row seat,
wherein a seating portion extends in the forward and rearward direction and is provided at the upper end of the luggage side trim and spaced rearward from the first protrusion, and
wherein when the covering shelf is in use, the first protrusion is fitted with a corresponding side bracket among the side brackets, and a damper among the dampers is seated on the seating portion, such that the covering shelf is installed to extend from the upper side of the luggage side trim in the forward and rearward direction.

5. The covering shelf apparatus of claim 4, wherein a second protrusion extends from a position on the luggage side trim, wherein the position is located downward and forward relative to the first protrusion, and
wherein when the covering shelf is not in use, the second protrusion is fitted with the corresponding side bracket, and the first protrusion is fitted with the damper, such that the covering shelf is positioned rearward of the second-row seat and stored in the upwardly inclined position.

6. The covering shelf apparatus of claim 5, wherein when changing the covering shelf to the upwardly inclined position from a state in which the covering shelf stands upright and the corresponding side bracket is positioned lower than the damper, the second protrusion fitted with the corresponding side bracket is configured to allow the covering shelf to rotate downward about the second protrusion when an upper end of the covering shelf is pushed downward such that the damper is moved to the first protrusion and then coupled to the damper.

7. The covering shelf apparatus of claim 5, wherein a bracket hole is formed in the corresponding side bracket, the first protrusion is penetratively fitted into the bracket hole when the covering shelf is in use, and the second protrusion is penetratively fitted into the bracket hole when the covering shelf is not in use.

8. The covering shelf apparatus of claim 4, wherein a damper hole is formed in the damper, and the first protrusion is penetratively fitted into the damper hole when the covering shelf is in use.

9. The covering shelf apparatus of claim 8, wherein a stopper protrusion is formed in an inlet of the damper hole and protrudes toward an inside of the damper hole to prevent the first protrusion, which is fitted into the damper hole, from being withdrawn.

10. The covering shelf apparatus of claim 4, wherein a bottom surface of the damper protrudes to an outside of the covering shelf, and the bottom surface of the damper is in contact with the seating portion provided on the luggage side trim to prevent noise when the covering shelf is in use.

11. The covering shelf apparatus of claim 10, wherein a noise prevention protrusion is formed on the bottom surface of the damper and provided to be in contact with the seating portion.

12. The covering shelf apparatus of claim 1, wherein a plurality of fixing protrusions is formed on the dampers, and the plurality of fixing protrusion is installed to penetrate the covering shelf to prevent the dampers from separating from the covering shelf.

13. The covering shelf apparatus of claim 1, wherein each of the dampers is formed as an integrated elastic body to absorb an impact and prevent noise.
